(19) United States
(12) Patent Application Publication
(10) Pub. No.: US 2008/0029126 A1
(43) Pub. Date: Feb. 7, 2008

(54) Compositions and methods for improved planarization of copper utilizing inorganic oxide abrasive

(76) Inventor: Terence M. Thomas, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/500,072

(22) Filed: Aug. 7, 2006

(51) Int. Cl. B24D 3/02; C23G 1/00; C09K 3/14

(52) U.S. Cl. 134/2; 51/308; 51/298; 51/303

(57) ABSTRACT

The present invention provides an aqueous composition useful for polishing copper on a semiconductor wafer at a down force pressure of at least less than 20.68 kPa, comprising by weight percent oxidizer, 0.001 to 5 inhibitor for a nonferrous metal, complexing agent for the nonferrous metal, 0.01 to 5 carboxylic acid polymer, 0.01 to 5 modified cellulose, 0.001 to 10 phosphorus-containing compound and 0.001 to 10 boehmite abrasive, wherein the boehmite increases the planarization rate of the copper.

### BACKGROUND OF THE INVENTION

The invention relates to chemical mechanical planarization (CMP) of semiconductor wafer materials and, more particularly, to CMP compositions and methods for polishing copper interconnects from semiconductor wafers in the presence of dielectrics and barrier materials.

Typically, a semiconductor wafer has a wafer of silicon and a dielectric layer containing multiple trenches arranged to form a pattern for circuit interconnects within the dielectric layer. The pattern arrangements usually have a damascene structure or a dual damascene structure. A barrier layer covers the patterned dielectric layer and a metal layer covers the barrier layer. The metal layer has at least sufficient thickness to fill the patterned trenches with metal to form circuit interconnects.

CMP processes often include multiple polishing steps. For example, a first step removes a metal layer from underlying barrier and dielectric layers. The first step polishing removes the metal layer, while leaving a smooth planar surface on the wafer with metal-filled trenches that provide circuit interconnects planar to the polished surface. First step polishing removes excess interconnect metals, such as copper at an initial high rate. After the first step removal, the second step polishing can remove a barrier that remains on the semiconductor wafer. This second step polishing removes the barrier from an underlying dielectric layer of a semiconductor wafer to provide a planar polished surface on the dielectric layer. The CMP is typically conducted at down force pressures of about 3 psi (20.68 kPa).

Unfortunately, the transition to ultra low k dielectric films require that the CMP be performed at lower pressures to avoid delamination of the films. However, decreasing the down force pressures negatively impacts the overall performance, including the polishing rate, of CMP. For example, the polishing rate for a conventional first step slurry is reduced to about 1000 Å/min when the pressure is reduced to about 1 psi, compared to about 3000 Å/min at 3 psi (20.68 kPa). Hence, when the pressure is decreased, the throughput is significantly impacted. In addition, at low pressures, planarization times may be negatively impacted as well. For example, at low pressures, planarization times may exceed the time to “breakthrough”, in particular, to the barrier layer. In other words, certain areas of the wafer will not have fully planarized before breakthrough and these areas will have unwanted dishing due to the unplanarized step.

Kaufman et al. (U.S. Pat. No. 6,620,037), discloses a typical slurry composition for polishing copper. The composition of Kaufman eliminates a film forming agent (e.g., BTA) in an attempt to increase polishing rates. However, the composition still requires a down force of 3 psi (20.68 kPa) or greater to be effective for removing copper (the composition of Kaufman provides a polishing rate of 2346 Å/min at 20.68 kPa). Consequently, the disclosure of Kaufman still suffers from the above-noted problems.

Hence, what is needed is an improved polishing composition and method for effectively polishing copper interconnects with reduced down force pressures and improved planarization efficiencies. In particular, there is a need for a composition and method for effectively polishing copper interconnects with down force pressures of 1 psi (6.89 kPa) and less for ultra low dielectric applications.

### STATEMENT OF THE INVENTION

In a first aspect, the present invention provides an aqueous composition useful for polishing copper on a semiconductor wafer at a down force pressure of at least less than 20.68 kPa, comprising by weight percent oxidizer, 0.001 to 5 inhibitor for a nonferrous metal, complexing agent for the nonferrous metal, 0.01 to 5 carboxylic acid polymer, 0.01 to 5 modified cellulose, 0.001 to 10 phosphorus-containing compound and 0.001 to 10 boehmite abrasive, wherein the boehmite increases the planarization rate of the copper.

In a second aspect, the present invention provides an aqueous composition useful for polishing copper on a semiconductor wafer comprising by weight percent 0.1 to 15 oxidizer, 0.001 to 5 inhibitor for a nonferrous metal, 0.001 to 10 complexing agent for the nonferrous metal, 0.01 to 5 carboxylic acid polymer, 0.01 to 5 modified cellulose, 0.001 to 10 phosphorus-containing compound and 0.02 to 1 boehmite abrasive, wherein the boehmite increases the planarization rate of the copper.

In a third aspect, the present invention provides a method for polishing copper from a semiconductor wafer comprising: contacting the wafer with a polishing composition, the wafer containing the copper, the polishing composition comprising by weight percent 0.1 to 15 oxidizer, 0.001 to 5 inhibitor for a nonferrous metal, 0.001 to 10 complexing agent for the nonferrous metal, 0.01 to 5 carboxylic acid polymer, 0.01 to 5 modified cellulose, 0.001 to 10 phosphorus-containing compound and 0.001 to 10 boehmite abrasive; pressing the wafer with a polishing pad at a down force pressure of at least less than 20.68 kPa; and polishing the wafer with the polishing pad, wherein the boehmite increases the planarization rate of the copper.

### DETAILED DESCRIPTION

The composition and method provide unexpected increase in polishing rates of copper interconnects at low down force pressures while providing improved planarization performance. “Planarization” is the selective removal of material from one area of the wafer at a different rate than at another area of the wafer such that in time, the two areas lie nearly on the same plane. Typically, planarization is accepted as being achieved when there is less than 300 Å/step change from one area to the next on the wafer or substrate. Hence, “improved planarization” represents a decrease in the amount of time required to achieve a 300 Å/step change from one area to the next on the wafer or substrate. The composition of the present invention utilizes the addition of phosphorus-containing compounds to effectively increase first step polishing rates of copper interconnects on the wafer at reduced down force pressures. The invention is particularly useful in ultra low k dielectric film applications. In addition, the composition includes an inorganic oxide abrasive, in particular, a hydrated aluminum oxide (“boehmite”), to improve planarization performance of the composition. Also, although the present invention has particular usefulness in copper interconnects, the present aqueous polishing composition also provides enhanced polishing of other metal interconnects, such as aluminum, nickel, iron, steel, beryllium, zinc, titanium, chromium and the like.

For purposes of this specification, a “phosphorus-containing” compound is any compound containing a phosphorus atom. A preferred phosphorus-containing compound is, for example, a phosphate, pyrophosphate, polyphosphate, phosphonate, including, their acids, salts, mixed acid salts, esters, partial esters, mixed esters, and mixtures thereof, for example, phosphoric acid. In particular, a preferred aqueous polishing composition can be formulated using, for example, the following phosphorus-containing compounds: zinc phosphate, zinc pyrophosphate, zinc polyphosphate, zinc phosphonate, ammonium phosphate, ammonium pyrophosphate, ammonium polyphosphate, ammonium phosphonate, diammonium phosphate, diammonium pyrophosphate, diammonium polyphosphate, diammonium phosphonate, guanidine phosphate, guanidine pyrophosphate, guanidine polyphosphate, guanidine phosphonate, iron phosphate, iron pyrophosphate, iron polyphosphate, iron phosphonate, cerium phosphate, cerium pyrophosphate, cerium polyphosphate, cerium phosphonate, ethylene-diamine phosphate, piperazine phosphate, piperazine pyrophosphate, piperazine phosphonate, melamine phosphate, dimelamine phosphate, melamine pyrophosphate, melamine polyphosphate, melamine phosphonate, melam phosphate, melam pyrophosphate, melam polyphosphate, melam phosphonate, melem phosphate, melem pyrophosphate, melem polyphosphate, melem phosphonate, dicyanodiamide phosphate, urea phosphate, including, their acids, salts, mixed acid salts, esters, partial esters, mixed esters, and mixtures thereof. Also, phosphine oxides, phosphine sulphides and phosphorinanes and of phosphonates, phosphites and phosphinates may be used, including, their acids, salts, mixed acid salts, esters, partial esters and mixed esters. A preferred phosphorus-containing compound is ammonium phosphate.

Advantageously, the phosphorus-containing compound of the polishing composition of the present invention is present in an amount effective to increase polishing rates at low down force pressures. It is believed that even a trace amount of the phosphorus-containing compound in the polishing composition is effective for polishing the copper. A satisfactory polishing rate at acceptable polishing down force pressures is obtained by using the phosphorus-containing compound in an amount of about 0.001 to about 10 weight percent of the composition. A preferred range for the phosphorus-containing compound is about 0.1 to about 5 weight percent of the composition. Most preferably, the phosphorus-containing compound is about 0.3 to about 2 weight percent of the composition.

Advantageously, the novel polishing composition contains about 0.01 to 5 weight percent of a carboxylic acid polymer. Preferably, the composition contains about 0.05 to 2 weight percent of a carboxylic acid polymer. Also, the polymer preferably has a number average molecular weight of about 1,000 to 1,500,000. In addition, blends of higher and lower number average molecular weight carboxylic acid polymers can be used. These carboxylic acid polymers generally are in solution but may be in an aqueous dispersion. The number average molecular weight of the aforementioned polymers are determined by GPC (gel permeation chromatography).

The carboxylic acid polymers are formed from unsaturated monocarboxylic acids and unsaturated dicarboxylic acids. Typical unsaturated monocarboxylic acid monomers contain 3 to 6 carbon atoms and include acrylic acid, oligomeric acrylic acid, methacrylic acid, crotonic acid and vinyl acetic acid. Typical unsaturated dicarboxylic acids contain 4 to 8 carbon atoms and include the anhydrides thereof and are, for example, maleic acid, maleic anhydride, fumaric acid, glutaric acid, itaconic acid, itaconic anhydride, and cyclohexene dicarboxylic acid. In addition, water soluble salts of the aforementioned acids also can be used.

Particularly useful are “poly(meth)acrylic acids” having a number average molecular weight of about 1,000 to 1,500,000 preferably 5,000 to 250,000 and more preferably, 20,000 to 200,000. As used herein, the term “poly(meth)acrylic acid” is defined as polymers of acrylic acid, polymers of methacrylic acid or copolymers of acrylic acid and methacrylic acid. Blends of varying number average molecular weight poly(meth)acrylic acids are particularly preferred. In these blends or mixtures of poly(meth)acrylic acids, a lower number average molecular weight poly(meth)acrylic acid having a number average molecular weight of 1,000 to 100,000 and preferably, 20,000 to 40,000 is used in combination with a higher number average molecular weight poly(meth)acrylic acid having a number average molecular weight of 150,000 to 1,500,000, preferably, 200,000 to 300,000. Typically, the weight percent ratio of the lower number average molecular weight poly(meth)acrylic acid to the higher number average molecular weight poly(meth)acrylic acid is about 10:1 to 1:10, preferably 5:1 to 1:5, and more preferably, 3:2 to 2:3. A preferred blend comprises a poly(meth)acrylic acid having a number average molecular weight of about 20,000 and a poly(meth)acrylic acid having a number average molecular weight of about 200,000 in a 2:1 weight ratio.

Advantageously, carboxylic acid containing copolymers and terpolymers can be used in which the carboxylic acid component comprises 5-75% by weight of the polymer. Typical of such polymer are polymers of (meth)acrylic acid and acrylamide or methacrylamide; polymers of (meth)acrylic acid and styrene and other vinyl aromatic monomers; polymers of alkyl (meth)acrylates (esters of acrylic or methacrylic acid) and a mono or dicarboxylic acid, such as, acrylic or methacrylic acid or itaconic acid; polymers of substituted vinyl aromatic monomers having substituents, such as, halogen, i.e., chlorine, fluorine, bromine, nitro, cyano, alkoxy, haloalkyl, carboxy, amino, amino alkyl and a unsaturated mono or dicarboxylic acid and an alkyl (meth)acrylate; polymers of monethylenically unsaturated monomers containing a nitrogen ring, such as, vinyl pyridine, alkyl vinyl pyridine, vinyl butyrolactam, vinyl caprolactam, and an unsaturated mono or dicarboxylic acid; polymers of olefins, such as, propylene, isobutylene, or long chain alkyl olefins having 10 to 20 carbon atoms and an unsaturated mono or dicarboxylic acid; polymers of vinyl alcohol esters, such as, vinyl acetate and vinyl stearate or vinyl halides, such as, vinyl fluoride, vinyl chloride, vinylidene fluoride or vinyl nitriles, such as, acrylonitrile and methacrylonitrile and an unsaturated mono or dicarboxylic acid; polymers of alkyl (meth) acrylates having 1-24 carbon atoms in the alkyl group and an unsaturated monocarboxylic acid, such as, acrylic acid or methacrylic acid. These are only a few examples of the variety of polymers that can be used in the novel polishing composition of this invention. Also, it is possible to use polymers that are biodegradeable, photodegradeable or degradeable by other means. An example of such a composition that is biodegradeable is a polyacrylic acid polymer containing segments of poly(acrylate comethyl 2-cyanoacrylate).

Advantageously, the solution contains 0.1 to 15 weight percent oxidizer. More preferably, the oxidizer is in the range of 5 to 10 weight percent. The oxidizing agent can be at least one of a number of oxidizing compounds, such as hydrogen peroxide (H₂O₂), monopersulfates, iodates, magnesium perphthalate, peracetic acid and other per-acids, persulfates, bromates, periodates, nitrates, iron salts, cerium salts, Mn (III), Mn (IV) and Mn (VI) salts, silver salts, copper salts, chromium salts, cobalt salts, halogens hypochlorites and a mixture thereof. Furthermore, it is often advantageous to use a mixture of oxidizer compounds. When the polishing slurry contains an unstable oxidizing agent such as, hydrogen peroxide, it is often most advantageous to mix the oxidizer into the composition at the point of use.

Further, the solution contains 0.001 to 5 weight percent inhibitor to control copper interconnect removal rate by static etch or other removal mechanism. Adjusting the concentration of an inhibitor adjusts the interconnect metal removal rate by protecting the metal from static etch. Advantageously, the solution contains 0.2 to 0.50 weight percent inhibitor. The inhibitor may consist of a mixture of inhibitors. Azole inhibitors are particularly effective for copper and silver interconnects. Typical azole inhibitors include benzotriazole (BTA), mercaptobenzothiazole (MBT), tolytriazole (TTA) and imidazole. BTA is a particularly effective inhibitor for copper and silver.

In addition to the inhibitor, the composition advantageously contains 0.001 to 10 weight percent complexing agent for the nonferrous metal. The complexing agent prevents precipitation of the metal ions by complexing the nonferrous metal interconnects. Advantageously, the composition contains 0.1 to 1 weight percent complexing agent for the nonferrous metal. Example complexing agents include acetic acid, citric acid, ethyl acetoacetate, glycolic acid, lactic acid, malic acid, oxalic acid, salicylic acid, sodium diethyl dithiocarbamate, succinic acid, tartaric acid, thioglycolic acid, glycine, alanine, aspartic acid, ethylene diamine, trimethyl diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, tannic acid, including, salts and mixtures thereof. Advantageously, the complexing agent is selected from the group consisting of acetic acid, citric acid, ethyl acetoacetate, glycolic acid, lactic acid, malic acid, oxalic acid and mixtures thereof. Most advantageously, the complexing agent is malic acid.

In addition, the polishing composition of this invention contains 0.01 to 5.0 weight percent of modified cellulose. Preferably, the composition contains 0.1 to 3 weight percent of modified cellulose. The addition of modified cellulose (for e.g. carboxymethyl cellulose) provides unexpected reduction of dishing values to the polishing composition. Exemplary modified cellulose are anionic gums such as agar gum, arabic gum, ghatti gum, karaya gum, guar gum, pectin, locust bean gum, tragacanth gums, tamarind gum, carrageenan gum, xantham gum, modified starch, alginic acid, mannuronic acid, guluronic acid, and their modifications and combinations.

Further, the polishing composition contains 0.001 to 10 weight percent abrasive to facilitate metal layer removal and improved planarization performance. Within this range, it is desirable to have the abrasive present in an amount of greater than or equal to 0.02 weight percent. Also, desirable within this range is an amount of less than or equal to 1 weight percent.

The abrasive has an average particle size of less than or equal to 150 nanometers (nm) for preventing excessive metal dishing, dielectric erosion and improving planarization. For purposes of this specification, particle size refers to the average particle size of the abrasive. More preferably, it is desirable to use an inorganic oxide having an average particle size of less than or equal to 70 nm. Further, minimal dielectric erosion and metal dishing advantageously occurs with an inorganic oxide having an average particle size of less than or equal to 35 nm. Decreasing the size of the inorganic oxide to less than or equal to 20 nm, tends to improve the selectivity of the polishing composition, but, it also tends to decrease the removal rate. In addition, the preferred inorganic oxide abrasive may include additives, such as dispersants, surfactants and buffers to improve the stability of the inorganic oxide. One such inorganic oxide abrasive is aluminum oxide hydroxide (“boehmite”) from Engelhard, of Iselin, N.J. Modified forms of inorganic oxides, such as, polymer-coated inorganic oxide particles and inorganic coated particles may also be utilized if desired. Also, other abrasives, including, those that are fumed, precipitated, agglomerated, etc., may be utilized.

The composition and method provide unexpected increase in polishing rates of copper interconnects at reduced down force pressures. In particular, the composition and method provide unexpected increase in polishing rates of copper interconnects at down force pressures of at least less than 3 psi (20.68 kPa). More particularly, the composition and method provide unexpected increase in polishing rates of copper interconnects at down force pressures of 1 psi (6.89 kPa) and less. The polishing composition or fluid of the present invention utilizes the addition of phosphorus-containing compounds to effectively increase polishing rates during first step polishing of copper interconnects on the wafer at low down force pressures of 1 psi and less. The aqueous composition comprises an oxidizer, inhibitor, complexing agent, polymers and phosphorus-containing compounds, and balance water. In addition, the present composition provides a substantial reduction in dishing of the copper circuits of the wafer in comparison to conventional polishing compositions. The novel polishing composition provides a substantially planar surface that is free of scratches and other defects that commonly result from polishing. The present composition is particularly useful in ultra low k dielectric film applications.

The compounds provide efficacy over a broad pH range in solutions containing a balance of water. This solution's useful pH range extends from at least 2 to 5. In addition, the solution advantageously relies upon a balance of deionized water to limit incidental impurities. The pH of the polishing fluid of this invention is preferably from 2.5 to 4.2, more preferably a pH of 2.6 to 3.8. The acids used to adjust the pH of the composition of this invention are, for example, nitric acid, sulfuric acid, hydrochloric acid, phosphoric acid and the like. Exemplary bases used to adjust the pH of the composition of this invention are, for example, ammonium hydroxide and potassium hydroxide. Advantageously, the addition of the phosphorus-containing compound provides greater stability and robustness to the present composition. In particular, the addition of the phosphorus-containing compound allows the present composition to provide effective polishing rates, substantially unaffected or independent of the pH.

The composition of the present invention is applicable to any semiconductor wafer containing a conductive metal, such as copper, aluminum, tungsten, platinum, palladium, gold, or iridium; a barrier or liner film, such as tantalum, tantalum nitride, titanium, or titanium nitride; and an underlying dielectric layer. For purposes of the specification, the term dielectric refers to a semi-conducting material of dielectric constant, k, which includes low-k and ultra-low k dielectric materials. The composition and method are excellent for preventing erosion of multiple wafer constituents, for example, porous and nonporous low-k dielectrics, organic and inorganic low-k dielectrics, organic silicate glasses (OSG), fluorosilicate glass (FSG), carbon doped oxide (CDO), tetraethylorthosilicate (TEOS) and a silica derived from TEOS.

### EXAMPLES

In the Examples, numerals represent examples of the invention and letters represent comparative examples. All example solutions contained, by weight percent, 0.50 BTA, 0.22 malic acid, 0.32 carboxymethyl cellulose (CMC), 0.10 copoly(methacrylic acid /acrylic acid) (200 k mw) having a monomeric molar ratio of 3:2, 9.00 hydrogen peroxide and 0.5 phosphate.

### Example 1

This experiment measured polishing rates of bulk copper from a semiconductor wafer at low down force pressures utilizing various abrasives. In particular, the test determined the effect of the addition of boehmite abrasives to the polishing rate during a first step polishing operation at 1 psi (6.89 kPa) and 1.5 psi (10.34 kPa). An Applied Materials, Inc. Mirra 472 200 mm polishing machine using an IC1010™ microporous polyurethane polishing pad (Rohm and Haas Electronic Materials CMP Inc.) under downforce pressure conditions of 1 psi (6.89 kPa) and 1.5 psi (10.34 kPa) and a polishing solution flow rate of 160 cc/min, a platen speed of 80 RPM and a carrier speed of 75 RPM planarized the samples. The samples were 200 mm copper blanket wafers. The polishing solutions had a pH of 2.8 adjusted with nitric acid. All solutions contained deionized water.

TABLE 1

| Test Samples | Presssure (psi) | Cu (Å/min) | TaN (Å/min) | Settle? |
|---|---|---|---|---|
| A1 | 1 | 3500 | 500 | N |
| A2 | 1.5 | 5500 | 700 | N |
| B1 | 1 | 4000 | 81 | N |
| B2 | 1.5 | 4300 | 226 | N |
| B3 | 1 | 4100 | 137 | N |
| B4 | 1.5 | 4700 | 172 | N |
| B5 | 1 | 3300 | 83 | N |
| B6 | 1.5 | 4500 | 142 | N |
| C1 | 1 | 3800 | 47 | Y |
| C2 | 1.5 | 4100 | 66 | Y |
| C3 | 1 | 4000 | 41 | Y |
| C4 | 1.5 | 4300 | 47 | Y |
| D1 | 1 | 4700 | −7 | Y |
| D2 | 1.5 | 5100 | −12 | Y |
| E1 | 1 | 2900 | 214 | N |
| E2 | 1.5 | 5700 | 477 | N |
| E4 | 1.5 | 5500 | 200 | N |
| E5 | 1 | 3700 | 182 | N |
| E6 | 1.5 | 5800 | 268 | N |
| 1 | 1 | 3800 | 1 | Y |
| 2 | 1.5 | 4500 | 5 | Y |
| 3 | 1 | 3700 | 10 | Y |
| 4 | 1.5 | 4600 | 6 | Y |

A1–A2 are neutral pH, 12 nm Klebesol particles from AZ–EM having a negative zeta potential.
B1–B6 are 12 nm alumina Klebesol particles having a positive zeta potential.
C1–C4 are gamma alumina particles from St. Gobain.
D1 and D2 are organic abrasive particles (Sunspheres) from the Rohm and Haas Company.
E1–E6 are spherical (delta) alumina particles from Nanophase.
1–4 are hydrated alumina (boehmite) from Engelhard and St. Gobain.

As illustrated in Table 1, the compositions containing the boehmite abrasives provided excellent suppression of TaN while providing acceptable levels of copper removal. For example, sample 1 provided a TaN removal rate of 1 (Å/min) while still providing a copper removal rate of 3800 (Å/min).

### Example 2

In this Example, the effect of varied amounts of boehmite on the polishing performance of the present slurry was investigated. All other parameters were the same as that of Example 1.

TABLE 2

| | | Cu Removal Rate | TaN Removal Rate |
|---|---|---|---|
| Test Samples | % Boehmite | (Å/min) | (Å/min) |
| 5 | 3 | 3500 | 95 |
| 6 | 1 | 5000 | 25 |
| 7 | 0.5 | 5600 | 10 |

As illustrated in Table 2 above, increased concentration of Boehmite lowered the copper removal rate while increasing the barrier removal rate. For example, in sample 5, the copper removal rate was 3500 (Å/min) while the TaN removal rate was 95 (Å/min). In contrast, in sample 7, the copper removal rate was 5600 (Å/min) while the TaN removal rate was 10 (Å/min).

### Example 3

In this Example, the effect of varied amounts of boehmite on the planarization performance of the present slurry was investigated. All other parameters were the same as that of Example 1.

TABLE 3

| | | Cu Rate | TaN Rate | |
|---|---|---|---|---|
| Test Samples | % Boehmite | (Å/min) | (Å/min) | P Time (sec) |
| 8 | 0 | 6000 | 2 | 90 |
| 9 | 1 | 4300 | 21 | 80 |

As illustrated in Table 3 above, increased concentration of Boehmite lowered the planarization time of the composition. For example, in sample 9, the planarization time was reduced from 90 sec in sample 8 to 80 sec in sample 9, when the concentration of the boehmite was increased from 0% to 1%.

### Example 4

In this Example, the effect of varied amounts of boehmite in the present composition on the step height of the polished wafer was investigated. All other parameters were the same as that of Example 1.

TABLE 4

| | Abrasive size | | Cu Rate | Step after 70 sec |
|---|---|---|---|---|
| Test Samples | (nm) | % Boehmite | (Å/min) | (Å) |
| 10 | 30 | 1 | 4300 | 980 |
| 11 | 70 | 1 | 5100 | 1100 |
| 12 | 30 | 2 | 2300 | 850 |
| 13 | 30 | 3 | 2900 | 980 |
| 14 | 30 | 0.5 | 5100 | 710 |
| 15 | 30 | 0.2 | 5300 | <300 |

As illustrated in Table 4 above, decreased concentration of boehmite lowered the step height of the polished wafer. For example, in sample 15, the step height was less than 300 (Å) when the boehmite concentration was 0.2 percent, as compared to 980 (Å) in sample 13 when the concentration of the boehmite was increased to 3 percent.

### Example 5

In this Example, the planarization efficiency changes at 30 and 70 seconds of polishing patterned wafers along with total copper removed at these times were investigated. All other parameters were the same as that of Example 1.

TABLE 5

| Test | | 30 sec | 30 sec Cu | | 70 sec Cu | |
|---|---|---|---|---|---|---|
| Sam- | % | % Effi- | Removed | 70 sec % | Removed | |
| ples | Abrasive | ciency | (Å) | Efficiency | (Å) | Planar? |
| F | 0 | 96 | 3200 | 64 | 7500 | N |
| G | 1% SiO₂ | 99 | 3400 | 66 | 8000 | N |
| 16 | 0.5 Al₂O₃ | 105 | 2800 | 81 | 6500 | Y |
| 17 | 0.2 Al₂O₃ | 81 | 2900 | 78 | 6700 | Y |

As illustrated in Table 5 above, the samples containing the boehmite abrasives provided planar surfaces after 70 seconds of polishing. In contrast, samples F and G, without boehmite, did not provide planar results.

The composition and method provide unexpected increase in polishing rates of copper interconnects at reduced down force pressures. In particular, the composition and method provide unexpected increase in polishing rates of copper interconnects at down force pressures of at least less than 3 psi (20.68 kPa). More particularly, the composition and method provide unexpected increase in polishing rates of copper interconnects at down force pressures of 1 psi (6.89 kPa) and less. The polishing composition or fluid of the present invention utilizes the addition of phosphorus-containing compounds to effectively increase polishing rates during first step polishing of copper interconnects on the wafer at low down force pressures of 1 psi and less. In addition, the composition includes an inorganic oxide abrasive, in particular, boehmite to improve planarization performance of the composition.

1. An aqueous composition useful for polishing copper on a semiconductor wafer at a down force pressure of at least less than 20.68 kPa, comprising by weight percent oxidizer, 0.001 to 5 inhibitor for a nonferrous metal, complexing agent for the nonferrous metal, 0.01 to 5 carboxylic acid polymer, 0.01 to 5 modified cellulose, 0.001 to 10 phosphorus-containing compound and 0.001 to 10 boehmite abrasive, wherein the boehmite increases the planarization rate of the copper.

2. The composition of claim 1 wherein the composition comprises by weight percent 0.02 to 1 boehmite.

3. The composition of claim 1 wherein the boehmite has a size between 20 nm to 150 nm.

4. The composition of claim 1 wherein the phosphorus-containing compound is selected from group comprising: phosphate, pyrophosphate, polyphosphate, phosphonate, and their acids, salts, mixed acid salts, esters, partial esters, mixed esters, and mixtures thereof.

5. The composition of claim 1 wherein the phosphorus-containing compound is selected from the group comprising: zinc phosphate, zinc pyrophosphate, zinc polyphosphate, zinc phosphonate, ammonium phosphate, ammonium pyrophosphate, ammonium polyphosphate, ammonium phosphonate, diammonium phosphate, diammonium pyrophosphate, diammonium polyphosphate, diammonium phosphonate, guanidine phosphate, guanidine pyrophosphate, guanidine polyphosphate, guanidine phosphonate, iron phosphate, iron pyrophosphate, iron polyphosphate, iron phosphonate, cerium phosphate, cerium pyrophosphate, cerium polyphosphate, cerium phosphonate, ethylene-diamine phosphate, piperazine phosphate, piperazine pyrophosphate, piperazine phosphonate, melamine phosphate, dimelamine phosphate, melamine pyrophosphate, melamine polyphosphate, melamine phosphonate, melam phosphate, melam pyrophosphate, melam polyphosphate, melam phosphonate, melem phosphate, melem pyrophosphate, melem polyphosphate, melem phosphonate, dicyanodiamide phosphate, urea phosphate, and their acids, salts, mixed acid salts, esters, partial esters, mixed esters, and mixtures thereof.

6. The composition of claim 1 wherein the carboxylic acid polymer comprises a blend of a poly(meth)acrylic acid, the blend comprising a first polymer having a number average molecular weight of 1,000 to 100,000 and at least a second polymer having a number average molecular weight of 150,000 to 1,500,000, the first and second polymers having a weight percent ratio of 10:1 to 1:10.

7. The composition of claim 1 wherein the modified cellulose is carboxymethyl cellulose.

8. An aqueous composition useful for polishing copper on a semiconductor wafer comprising by weight percent 0.1 to 15 oxidizer, 0.001 to 5 inhibitor for a nonferrous metal, 0.001 to 10 complexing agent for the nonferrous metal, 0.01 to 5 carboxylic acid polymer, 0.01 to 5 modified cellulose, 0.001 to 10 phosphorus-containing compound and 0.02 to 1 boehmite abrasive, wherein the boehmite increases the planarization rate of the copper.

9. A method for polishing copper from a semiconductor wafer comprising:
contacting the wafer with a polishing composition, the wafer containing the copper, the polishing composition comprising by weight percent 0.1 to 15 oxidizer, 0.001 to 5 inhibitor for a nonferrous metal, 0.001 to 10 complexing agent for the nonferrous metal, 0.01 to 5 carboxylic acid polymer, 0.01 to 5 modified cellulose, 0.001 to 10 phosphorus-containing compound and 0.001 to 10 boehmite abrasive;
pressing the wafer with a polishing pad at a down force pressure of at least less than 20.68 kPa; and
polishing the wafer with the polishing pad, wherein the boehmite increases the planarization rate of the copper.

10. The composition of claim 1 wherein the composition comprises by weight percent 0.02 to 1 boehmite.
